(19) United States
(12) Patent Application Publication
(10) Pub. No.: US 2006/0013344 A1
(43) Pub. Date: Jan. 19, 2006

(54) Method and system for maximum likelihood detection

(75) Inventor: Chia-Yen Chang, Taipei City (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/181,834

(22) Filed: Jul. 15, 2005

(30) Foreign Application Priority Data
Jul. 16, 2004 (TW) 093121422

(51) Int. Cl. H04L 27/06

(52) U.S. Cl. 375/341

(57) ABSTRACT

Method and system are provided for maximum likelihood detection on information channel, especially relate to detect abnormal signal pattern and change the branch metrics weighting of maximum likelihood detector to reduce effects introduced by noises or abnormal signals, therefore improve the detection performance. The method for adjusting branch metrics weighting could been implemented by multiply the branch metrics weighting with a predetermined coefficient or adjust it in accordance to a look-up table. Also a maximum likelihood detection method applied for CD/DVD drive system has been disclosed.

### BACKGROUND OF THE INVENTION

1. Field of the Invention

The presented invention relates to a method and system for maximum likelihood detection, especially relates to change the branch metrics weighting of maximum likelihood detector to improve detection performance.

2. Description of the Prior Art

Maximum likelihood (ML) detection is a common detection technique, which is widely used in different areas such as a communication system, image and voice process, digital data storage . . . etc. Generally speaking, the ML detection could be classified into two types: hard-decision and soft-decision. The hard-decision technique forces the received analog signals, in the communication system, for example, classified into some specific quantification levels in accordance to ideal signals, but soft-decision technique retains the original magnitude of received analog signals to perform maximum likelihood detection. Soft-decision gains better detection performance but within more complicated detection circuits. However, as the improvement of electronic circuits, soft-decision is becoming more and more popular.

Viterbi algorithm is commonly used for maximum likelihood detection, which includes 3 major steps: calculate the distance between received and ideal signals to obtain branch metrics; accumulate the branch metrics into path metrics for each state nodes; and determine a survivor path for the received signal sequence and then decode. Overview the steps of Viterbi algorithm, for each received signal sequence's component, first calculate the distance (for example, the square difference) with an ideal signal sequence component and obtain the branch metrics entering each state node of the component. Next, for each state, accumulate current branch metrics with accumulated path metrics of the previous component's to obtain the path metrics. After finishing the path metrics calculation for the last received signal sequence component, trace back to initial state node of first received signal sequence component to determine a survivor path with smallest path metrics, then decode received signal sequence and obtain original data signal according to the survivor path.

Although Viterbi algorithm is an optimum maximum likelihood detection algorithm, sometimes because of abnormal signals or noise influences, the errors between received and ideal signal sequence component become too large, which result in the path metrics after branch metrics calculation are not correct and obtain a wrong survivor path, generating decoding errors and influencing the accuracy of detection.

Referring to FIG. 1, FIG. 1 illustrate the trellis diagram for Viterbi algorithm decoding with a soft-decision. Assuming there is a data signal sequence D=(D[1],D[2],D[3], . . . ,D[12])=(0,1,1,1,0,0,0,0,1,1,1,1), and the channel response model of information channel is a partial response channel PR(1,2,1). The error-free ideal received signal sequence I should be: I=(I[1],I[2], . . . ,I[10])=(2,4,2,−2,−4,−4,−2,2,4,4), and the actual received signal sequence is R=(R[1],R[2],R[3], . . . ,R[10])=(1.7,4,3.8,−1.9,0.1,−3.8,−1.8,1.9,4,2,4). The four states of the trellis diagram are represented as S0, S1, S2, S3 individually. Take the received signal sequence component R[5] for example.

The received signal sequence component R[5] is 0.1, but the ideal received signal sequence component I[5] is −4, which has a large error occurs. Calculate the branch metrics 10 from state S0 of previous sequence component R[4] entering state S0 of the current sequence component (represent by path S0->S0), the branch metrics 10 is |0.1−(−4)|²=16.81, and the branch metrics 12 for path S2->S0 is |0.1−(−2)|²=4.41. Then accumulate branch metrics 10 and 12 with the path metrics of state S0 and S2 of R[4] individually, and obtain the path metrics of state S0 of R[5] is 16.81+3.34=20.15 and 15.34+4.41=19.75 individually. Therefore it concludes that the state of the previous signal sequence component is S2, in other words, determine the entering path for state S0 of received signal sequence component R[5] is S2->S0, which makes the detection unable to achieve the correct survivor path 120 but the wrong survivor path 100, and then influence the signal decoding result (received signal R[3] is decoded as 1 from 0).

As mentioned above, an abnormal signal occurs in the prior Viterbi algorithm detection that may cause serious problems, which makes an uncorrectable error. If it's possible to reduce the influence of abnormal signals, the detection accuracy will be improved.

### SUMMARY OF THE INVENTION

It is therefore an object of the invention to provide a method for maximum likelihood detection, which changes the branch metrics weighting of the maximum likelihood detection via detecting the occurrence of abnormal signals, to reduce the influence caused by noise or abnormal signals and improving the detection accuracy.

The another object of the invention is to provide a system for maximum likelihood detection, the system includes: a signal receiving device, an abnormal signal-detecting device, a control device, and a maximum likelihood detection device with variable branch metrics weighting to carry out the operations of above method.

Also the invention provides different means to adjust branch metrics weighting in order to improve maximum likelihood detection accuracy.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 illustrates the trellis diagram for Viterbi algorithm decoding with hard-decision;

FIG. 2 illustrates the trellis diagram for Viterbi algorithm decoding of the invention with soft-decision;

FIG. 3 shows a flow chart of an embodiment of the invention;

FIG. 4 shows the system of an embodiment of the invention; and

FIG. 5 shows an another embodiment of the invention applied for CD/DVD drive system.

### DESCRIPTION OF THE PREFERRED EMBODIMENT

As discussed above, one characteristic of the invention is that the detector takes use of detected abnormal signals to improve the maximum likelihood detection before decoding a received signal. Hence when some specific signal pattern has been observed, it's able to determine if the signal is an abnormal signal or an error has occurred because of a large noise.

Now if original digital data signals are encoded in RLL(2,10) (run length limited) code, the ideal signal levels of a received signal which was transmitted through a partial response channel PR(1,2,1) are 4, 2, −2, −4, and the received signal sequence will not have some specific signal patterns, such as (2,−2,2),(−2,2,−2),(−2,4,−2),(2,−4,2) that positive and negative signal appears in turn, and the difference of consecutive two received signal's level will not be over 6. Hence if one of the above situations occurs and detected on the receiver end, it concludes the received signal is abnormal.

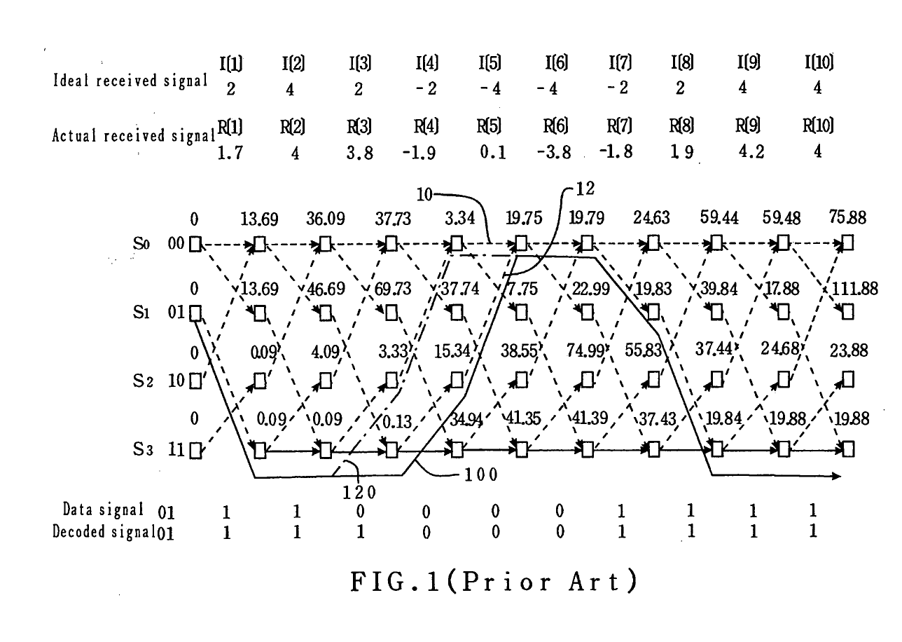

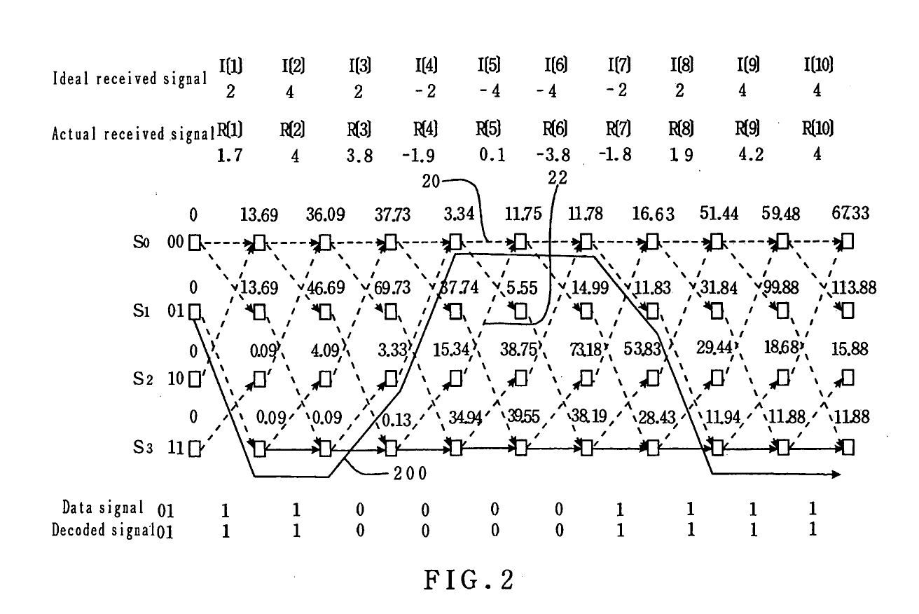

FIG. 2 illustrates the trellis diagram for Viterbi algorithm decoding of the invention with soft-decision. Referring to FIG. 2, the actual received signal sequence components R[3], R[4], R[5] are 3.8, −1.9, and 0.1. If quantify them in hard-decision, the received signal sequence has a (4,−2,2), in other words, a (positive, negative, positive) (represented in +,−,+ form) signal pattern. Because it's impossible for an ideal received signal which is generated after a RLL(2,10) encoded signal transmitting through a partial response channel PR(1,2,1), having such signal pattern, then determine R[5] is an abnormal signal. As determining the signal component R[5] is abnormal, the invention discloses a method to adjust the branch metrics weighting. In the embodiment, the invention discloses a mean, that multiplying the branch metrics weighting for each state of signal component R[5] with a coefficient ,such as 0.5, in other words, it means to halve original branch metrics of each state. For state S0 of R[5], the branch metrics 20 which is entering from S0 of previous component R[4] (path S0->S0) becomes: 0.5*|0.1−(−4)|²=8.41, the branch metrics 22 (path S2->S0) becomes: 0.5*|0.1−(−2)|²=2.21. Referring to FIG. 1, the original branch metrics is 16.81 and 8.41 individually. Accumulate branch metrics 20 and 22 with the path metrics for state S0 and S2 of R[4], we have the path metrics for state S0 of R[5] which equals to 8.41+3.34=11.75 and 2.21+15.34=17.55 for each other, therefore determine the path entering state S0 of R[5] is S0->S0. At the last step of determining a survivor path, it could achieve the correct survivor path 200 so that the receiver end could decode the received signal correctly. The calculations of path metrics and branch metrics for state S1, S2, and S3 are the same to S0, which are not explained redundantly here.

As the method for adjusting branch metrics weighting discussed above, besides multiply the branch metrics weighting with a predetermined coefficient, it could also establish a look-up table to adjust branch metrics weighting in accordance to different abnormal signal pattern. For example, if the signal pattern of received signal sequence is (2,−2,4), multiply the branch metrics weighting with a coefficient 0.5; if the signal pattern of received signal sequence is (2,−2,2), the coefficient is 0.7; or if the signal pattern is (−2,2,−2), set the branch metrics for each state as some specific values directly. There are many different means to make the equivalent modification, and these means are unlimited in the invention.

In prior art, it shows the incorrect branch metrics will result in decoding error, and if makes use of the method of the invention, the decoding performance of maximum likelihood detection could be improved.

It's enhanced that the encoding method for digital data signal is not limited in RLL code, and the information channel is not only limited on the partial response channel PR(1,2,1). As long as the compositions of the encoding method and information channel could make the receiver end determining an abnormal signal before decoding procedure, that the invention could apply on them.

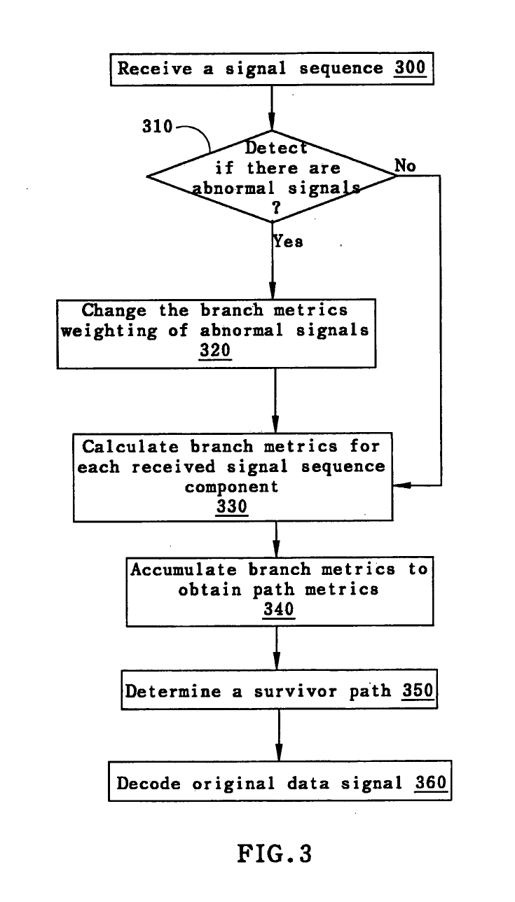

FIG. 3 is the flow chart of an embodiment of the invention. When a digital signal is transmitted through an information channel, and received a signal sequence which retains it original signal magnitude (step 300). In step 310, first perform an abnormal signal detecting operation on received signal sequence, to determine if there are abnormal signals. If abnormal signal have been detected, adjust the branch metrics weighting of detected abnormal signal (step 320), and then calculate the branch metrics of the received signal sequence afterwards (step 330); if no abnormal signal is detected, calculate the branch metrics of the received signal sequence directly (step 330). After the calculations of branch metrics, accumulate every branch metrics and obtain the path metrics for each state node of received signal sequence (step 340). As the path metrics of the last signal sequence's component have been obtained, trace back to the initial state and determine a survivor path with the smallest accumulated path metrics (step 360). Finally the detector could decode the received signal sequence to the original digital data according to the survivor path (step 360). Herein step 330 to step 360 is the original decoding procedures of prior Viterbi algorithm.

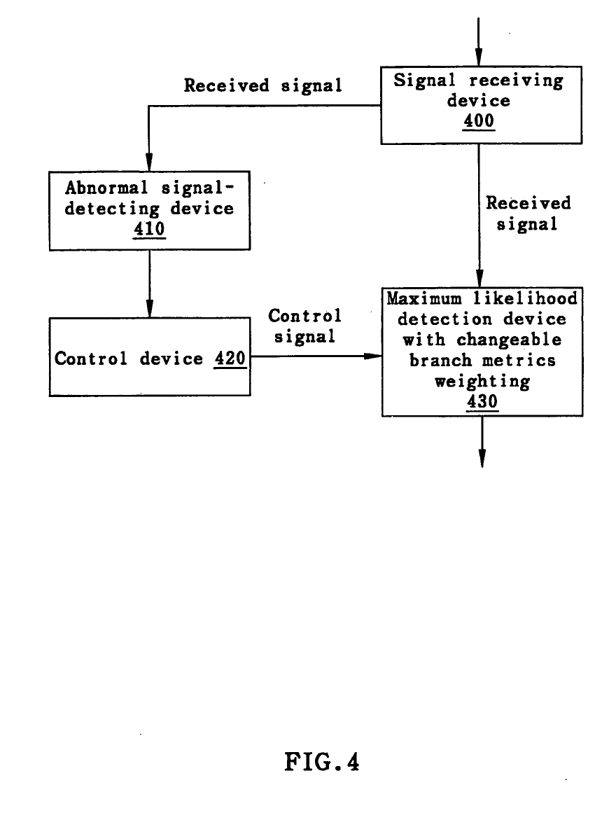

The invention also discloses a system for adjusting the maximum likelihood detection, and FIG. 4 is an embodiment of the invention. The disclosed system of the invention includes: a signal receiving device 400, an abnormal signal-detecting device 410, a control device 420, and a maximum likelihood detection device with variable branch metrics weighting 430. The signal receiving device 400 could be a RF receiver module, which is used to receive analog signals, wherein the analog signals are generated after an encoded digital data signal transmitted through an information channel. The abnormal signal-detecting device 410 detects if there are error occurs and inform the control device 420 the detection results. The control device 420 provides a control signal to the maximum likelihood detection device 430 in accordance to the control signal and adjusts the branch metrics weighting of maximum likelihood detection device 430. Finally, the maximum likelihood detection device 430 is used to decode the received analog signals back to the original digital data signal, which changes the branch metrics weighting in accordance to the control signal of control device 420.

The control device 420 is not only implemented in hardware circuit, but also in software program. And the system of the invention could also be integrated into a chip having the above functions, or implemented by compositions of electronic devices. The methods for adjusting branch metrics weighting of the control device 420 could be: multiply the original branch metrics weighting with a predetermined coefficient, or adjusted by a look-up table in accordance to different received signal patterns. The detail method for adjusting branch metrics weighting has been discussed above so that it's not explained redundantly here.

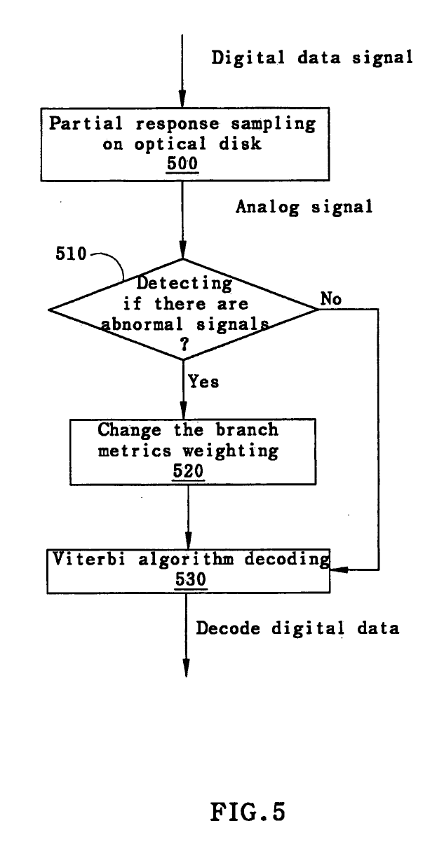

The presented invention may also apply on a CD/DVD drive system. The information channel of optical storage disk, has inter-symbol interference (ISI) situation. In order to reduce the influence to the reading performance caused by ISI, the pickup head of CD/DVD drive takes use of partial response sampling technique to reduce the influence of ISI, hence the sampling procedure of the pickup head could be thought as a digital data signal transmitted through a partial response channel such as PR(1,2,1) or PR(1,2,2,1) . . . etc. In optical storage disk, RLL code (especially RLL(1,7) and RLL(2,10)) is the most common encoding method. The RLL encoded digital data signal transmitting through a partial response channel such as PR(1,2,1) has a characteristic that, the difference between two consecutive received signals that are not over 6 (when available signal level is 4,2,−2, and 4) and signal pattern is (+,−,+) or (−,+,−). For CD/DVD drive, therefore, the read analog signal from disk could determine if there are abnormal signals that could apply on the disclosed maximum likelihood detection method. FIG. 5 is an another embodiment of the invention, which is a flow chart of maximum likelihood detection for CD/DVD drive system. First the pickup head of CD/DVD drive reads out the digital data recorded on disk via partial response sampling technique and obtain an analog signal sequence (step 500). Next detecting and determining if there are abnormal signals that occur in the analog signal sequence (step 510). If no abnormal signal has been detected, decode the analog signal sequence via Viterbi algorithm directly (step 530). Otherwise, if there are abnormal signals detected, adjust the branch metrics weighting of the abnormal signal component first, and then decode via Viterbi algorithm. Detail operations of the partial response sampling is easily carried out for related professions skilled in the art and, the details about Viterbi algorithm procedures and method for adjusting branch metrics weighting have been discussed above that are not explained redundantly here.

The abnormal signal pattern changes with a different partial response channel model. When the storage density becomes larger such as developing technology HD-DVD (High Definition DVD) and BD (Blu-ray Disc) or applied the partial response sampling is different, the received analog signal will have a different signal pattern, and so do abnormal signal patterns. Therefore if the encoding method and sampling technique choose properly as designing a CD/DVD drive system, then the disclosed method for adjusting maximum likelihood detection could be applied to increase the detection accuracy.

The above-mentioned are only the preferred embodiments of the present invention, not intended to limit the scope thereof. It will be appreciated and carried out by those professions skilled in the art. Thus, many modifications of the embodiments that can be made without departing from the spirit of the present invention should be covered by the following claims.

What is claimed is

1. A method for maximum likelihood detection, comprising:
receiving a signal sequence, wherein said signal sequence composes of a plurality of signal components;
obtaining a plurality of signal patterns from said plurality of signal components;
adjusting at least one branch metrics weighting of said plurality of signal components in accordance to at least one of said signal patterns; and
decoding said signal sequence in accordance to said branch metrics weighting via Viterbi algorithm.

2. The method for maximum likelihood detection of claim 1, wherein the receiving step receives a digital data signal which is transmitted through an information channel with a known channel response.

3. The method for maximum likelihood detection of claim 2, where said digital data signal is encoded with an encoding method to be with a specific range after transmitted through said information signal.

4. The method for maximum likelihood detection of claim 3, wherein said encoding method includes RLL (run length limited) coding.

5. The method for maximum likelihood detection of claim 3, wherein if said signal pattern is at said specific signal range of said signal sequence, said branch metrics weighting keeps the same.

6. The method for maximum likelihood detection of claim 3, wherein if said signal pattern is out of said specific signal range of said signal sequence, a method for adjusting branch metrics weighting is used to adjust said branch metrics weighting.

7. The method for maximum likelihood detection of claim 6, wherein said method for adjusting branch metrics weighting includes multiplying said branch metrics weighting with a predetermined coefficient.

8. The method for maximum likelihood detection of claim 3, wherein said method for adjusting branch metrics weighting includes adjusting said branch metrics weighting in accordance to a look-up table.

9. A system for maximum likelihood detection, comprising:
a signal receiving device for receiving a signal sequence;
an abnormal signal-detecting device connecting to said signal receiving device, and detecting whether if said received signal sequence is abnormal;
a control device connecting to said abnormal signal-detecting device, and provides a control signal to adjust at least one branch metrics weighting in accordance to the detection result of said abnormal signal-detecting device; and
a maximum likelihood detection device with variable branch metrics weighting, said maximum likelihood detection device connecting said control device and said signal receiving device for inputting said receiving signal and decoding said received signal via Viterbi algorithm in accordance to said branch metrics weighting adjusted by said control signal of said control device.

10. The system for maximum likelihood detection of claim 9, wherein said signal receiving device includes a RF (radio frequency) receiving module.

11. The system for maximum likelihood detection of claim 9, wherein said maximum likelihood detection device with variable branch metrics weighting includes a Viterbi decoder.

12. The system for maximum likelihood detection of claim 9, wherein said control device adjusts said branch metrics weighting by multiplying said branch metrics weighting with a predetermined coefficient.

13. The system for maximum likelihood detection of claim 9, wherein said control device adjusts said branch metrics weighting by a look-up table.

14. The system for maximum likelihood detection of claim 9, wherein said control device may be implemented by software program.

15. The system for maximum likelihood detection of claim 9, wherein said signal receiving device, said abnormal signal-detecting device, said control device, and said maximum likelihood detection device are integrated into a chip integrating above functions or composition circuits of electronic devices.

16. A maximum likelihood detection method applied for CD/DVD drive system, said method comprises:
reproducing a signal sequence from an optical storage medium, wherein said signal sequence composes a plurality of signal components;
obtaining a plurality of signal patterns of said plurality of signal components;
adjusting at least one branch metrics weighting of said signal components in accordance to at least one of said signal patterns; and
decoding said signal sequence in accordance to said branch metrics weighting via Viterbi algorithm.

17. The maximum likelihood detection method of claim 16, wherein said signal sequence is compliant by RLL code.

18. The maximum likelihood detection method of claim 16, wherein the reproducing step is implemented by partial response sampling method.

19. The maximum likelihood detection method of claim 16, wherein said method for adjusting branch metrics weighting includes multiplying said branch metrics weighting with a predetermined coefficient.

20. The maximum likelihood detection method of claim 16, wherein said method for adjusting branch metrics weighting includes adjusting said branch metrics weighting in accordance to a look-up table.
